(19) United States
(12) Patent Application Publication
(10) Pub. No.: US 2015/0115714 A1
(43) Pub. Date: Apr. 30, 2015

(54) METHOD AND SYSTEM FOR POWERING A LOAD

(71) Applicant: Control Techniques Limited, Newtown (GB)

(72) Inventor: Ramón Troy FERRARONS, Barcelona (ES)

(21) Appl. No.: 14/530,152

(22) Filed: Oct. 31, 2014

(30) Foreign Application Priority Data
Oct. 31, 2013 (ES) 201331603

(51) Int. Cl. H02J 4/00; G06F 1/28

(52) U.S. Cl. CPC H02J 4/00; G06F 1/28
USPC 307/23

(57) ABSTRACT

A method of controlling an electrical power supply to a load, wherein said load has an associated power threshold, is provided. The method comprises using a first electrical power source to generate a first amount of power for supply to the load, wherein said first electrical power source comprises a renewable source, and determining whether to supply a second amount of power to the load from a second, different electrical power source. If it is determined that the second electrical power source should be used to supply a second amount of power to the load, controlling an output of the second electrical power source so that a combined amount of power supplied to the load from the first and second electrical power sources meets the power threshold associated with the load.

### CROSS-REFERENCE TO RELATED APPLICATION

This application claims the benefit and priority of Spanish Patent Application No. 201331603 filed Oct. 31, 2013. The entire disclosure of the above application is incorporated herein by reference.

### FIELD

The disclosure relates to a method and system for powering a load, preferably an AC load, in which power may be provided to the load by DC and AC voltage sources. The AC load may be for example an AC motor for a water pump or a compressor.

### BACKGROUND

An AC transmission grid is used as the primary source of electricity for many applications. The costs associated with obtaining electricity from the grid to power applications can be significant and the price of electricity typically increases every month. As a result, many consumers schedule the use of their applications to coincide with times when the cost of obtaining electricity from the grid is at a minimum. Power plants that supply electricity usually maintain a constant output, since increasing or reducing the production of electricity is not desirable. Most high power applications, for example factories, are not operated during the night for practical reasons, and therefore the price electricity companies charge to supply electricity from the grid is usually lowest during the night. Due to the resultant high costs of electricity during the day, many high power applications are forced to only operate for a limited time during the day (for example 8 hours or less). However, those high power applications that are not required to operate during the day, such as pumps for agriculture for which timing is not important, are often operated during the night to save costs.

DC electricity produced by photovoltaic (PV) arrays in association with inverters can be sold to electrical companies by being “injected” into the AC transmission grid. However, electrical companies are often reluctant to buy energy from other sources or allow injections into the AC grid, and therefore using the PV energy in this way may not be possible in practice. Instead of selling energy to electrical companies, one possible theoretical solution for producers of DC electricity from PV arrays is to use the AC grid as only a temporal bus, and then try to achieve a net 0V between the consumed current and the current injected into the AC transmission grid. However electrical companies often do not allow this approach.

Known systems either just use energy from the AC grid, or use renewable sources such as PV arrays to “inject” energy in to the AC grid, and then take energy from the AC grid.

There is a desire for a more efficient and cost effective way to manage energy from both renewable sources and the grid.

### SUMMARY

An invention is set out in the claims.

According to a first aspect, a method of controlling an electrical power supply to a load, wherein said load has an associated power threshold, is provided. The method comprises: using a first electrical power source to generate a first amount of power for supply to the load, wherein said first electrical power source comprises a renewable source; comparing the first amount of power generated by the first electrical power source to the power threshold associated with the load; as a result of said comparison, determining whether to supply power to the load from the first power source and further determining whether to supply a second amount of power to the load from a second, different electrical power source; if it is determined that the second electrical power source should be used to supply a second amount of power to the load, controlling an output of the second electrical power source so that a combined amount of power supplied to the load from the first and second electrical power sources meets the power threshold associated with the load.

The method may also comprise the step of controlling an output of the first electrical power source so that the first amount of power generated by the first electrical power source is maximised.

The first amount of power generated by the first electrical power source may be maximised using Maximum Power Point Tracking (MPPT).

The method may further include the step of, when the comparison step indicates that there is a shortfall amount between the first amount of power generated by the first electrical power source for supply to the load and the power threshold associated with the load, controlling an output of the second electrical power source so that the second amount of power generated by the second electrical power source is as close as possible to said shortfall amount.

The second electrical power source may be arranged to provide electrical power at a substantially constant voltage and the method may further comprise controlling a current level for the second electrical power source in order to control the second amount of power supplied to the load by the second electrical power source.

The power threshold associated with the load may comprise an amount of power required by the load in order to achieve an operational requirement, and the operational requirement may comprise any of: operating at a predetermined speed, operating at a predetermined torque, operating to achieve a predetermined height or volume of fluid.

The power threshold associated with the load may be represented by a voltage threshold of a bus or drive.

The drive may comprise the bus electrically connected to an inverter.

The inverter or drive may be configured to output a low AC voltage, for example 400Vac.

The inverter or drive may be configured to output an AC voltage lower than that required by the load.

The load may be a high voltage load, for example a load with an operational voltage of 1000Vac.

The second electrical power source may be arranged to output to a first voltage converter before power from the second electrical power source is output to the bus or drive.

The inverter or drive may be arranged to output to a second voltage converter before power from the inverter or drive is output to the load.

A computer, processor or controller may be adapted to perform the method of controlling an electrical power supply to a load, and a computer readable medium may be provided which has computer-executable instructions adapted to cause a computer system to perform the method.

According to a second aspect, a system for controlling an electrical power supply to a load, wherein said load has an associated power threshold, is provided. The system comprises: a first electrical power source arranged to generate a first amount of power for supply to the load, wherein said first electrical power source comprises a renewable source; means for comparing the first amount of power generated by the first electrical power source to the power threshold associated with the load; means for determining, as a result of said comparison, whether to supply power to the load from the first power source, and means for further determining whether to supply a second amount of power to the load from a second, different electrical power source; means for controlling an output of the second electrical power source so that, if it is determined that the second electrical power source should be used to supply a second amount of power to the load, a combined amount of power supplied to the load from the first and second electrical power sources meets the power threshold associated with the load.

The system may further comprise a first voltage converter, wherein the second electrical power source is arranged to output to the first voltage converter before power from the second electrical power source is output to the bus or drive.

The system may further comprise a second voltage converter, wherein the bus or drive is arranged to output to the second voltage converter before power from the bus or drive is output to the load.

The first voltage converter may be a transformer, and the second voltage converter may also be a transformer.

### BRIEF DESCRIPTION OF THE DRAWINGS

Embodiments will now be described, by way of example only, with respect to the appended figures, of which:

FIG. 1 shows a block diagram of a known system for powering an AC load.

FIG. 2 shows a block diagram of a first embodiment of an improved system for powering an AC load.

FIG. 3 shows a block diagram of a second embodiment of an improved system for powering multiple AC loads.

### DETAILED DESCRIPTION

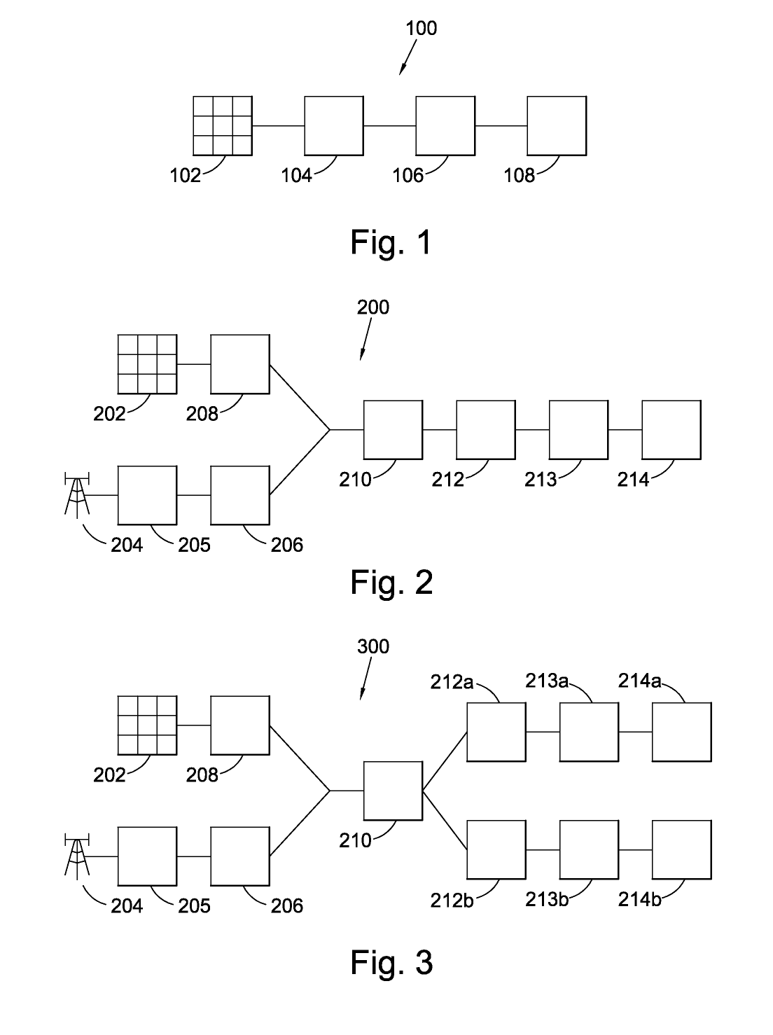

FIG. 1 shows an example of a known system. A photovoltaic array 102 is a standard array of photovoltaic cells which convert solar energy into an electrical output. The electrical energy produced by the photovoltaic array 102 is provided to a DC-DC converter 104. The DC-DC converter 104 serves two functions: the first is to step up or step down the DC voltage to an appropriate level for the load; the second is to perform maximum power point tracking (MPPT), which may conventionally be achieved by sampling the output of the photovoltaic array 102 and obtaining a maximum output power by regulating the voltage and current output by the photovoltaic array 102. The MPPT therefore takes into account environmental conditions which the photovoltaic array 102 is subjected to, and aims to make the photovoltaic array 102 as efficient as possible in view of those conditions, thereby maximising the output power accordingly.

The DC voltage output from the DC-DC converter 104 is supplied to a DC-AC inverter 106 to convert the received DC voltage into an output AC voltage. The AC voltage output from the DC-AC inverter 106 is provided to power an AC load 108. The system of FIG. 1 is therefore able to harness solar energy using the photovoltaic array 102, and use this harnessed energy to power an AC load 108. This system is cost-effective for lower power applications, for example AC loads with an operating voltage of less than 690V. A typical AC load for the system of FIG. 1 has an operating voltage of 400V.

An improved system and method for providing electrical power to a load is disclosed herein. A first embodiment will now be described by way of example only, in relation to FIG. 2. In this embodiment, a photovoltaic array (PV array) 202 converts solar energy into a DC voltage output. The DC voltage output from the PV array 202 is fed to a DC bus 210 via a DC filter 208.

The DC voltage output from the DC bus 210 is provided to an inverter 212 which converts this input DC voltage into an output AC voltage. The inverter 212 comprises inverter software including maximum power point tracking (MPPT) software, in order to maximise the power provided by the photovoltaic array 202. MPPT takes into account the effects of fluctuating environmental conditions on the ability of the cells in the PV array 202 to produce power. For any given set of environmental and other operating conditions, there will be a single point at which the values of current (I) and voltage (V) are suitable to produce maximum power from a cell. MPPT aims to alter the values of I and V for the cell (or array) in order to achieve that maximum power at all times, or at least at regular intervals.

As the skilled person would understand, for a photovoltaic cell or array such as the PV array 202 in FIG. 2, the maximum voltage output is achieved when the current drawn from the PV array 202 is OA, and conversely the maximum current may be drawn from the PV array 202 when the voltage output is 0V. Therefore, when the PV array 202 is not outputting its maximum voltage, the voltage output may be increased by drawing less current from the PV array 202. Conversely, the voltage output by the PV array 202 can be decreased by drawing more current from the PV array 202. In order for the MPPT to achieve a maximum power output for the PV array 202, a balance is made between the voltage output and current drawn. In the embodiment of FIG. 2, the MPPT of the PV array 202 is monitored by monitoring the voltage output of the PV array 202. Since the voltage output by the PV array 202 is provided to the DC bus 210, the voltage across the DC bus 210 is equal to the voltage output by the PV array 202 and therefore the voltage output by the PV array 202 can be monitored by monitoring the voltage across the DC bus 210.

When the PV array 202 is operating at its maximum power point, the voltage output by the PV array 202 is the maximum power point voltage, V_{MPPT}. The value of V_{MPPT} changes under varying environmental conditions. Since the voltage output by the PV array 202 varies depending on the amount of current drawn from the PV array 202, the inverter can maintain the output of the PV array 202, and therefore the voltage across the DC bus 210, to be equal to V_{MPPT} by varying the amount of current drawn from the PV array 202. The MPPT in the inverter 212 therefore maximises the power output of the PV array 202.

In the absence of energy sources other than the PV array (which are discussed further below), the inverter 212 can control the operation of a load such as an AC load 214 in order to control the amount of current drawn from the PV array 202. The AC load 214 may be a motor, a compressor or other load requiring an AC voltage to operate. In the example of a motor, the inverter 212 increases the amount of current drawn from the PV array 202 by increasing the speed of rotation of the motor. Conversely, the inverter 212 may decrease the amount of current drawn from the PV array 202 by decreasing the speed of rotation of the motor. As previously mentioned, an increase or decrease in the current drawn from the PV array 202 causes a decrease or increase respectively in the voltage output by the PV array 202. Therefore, MPPT in the inverter 212 may achieve a maximum power output of the PV array 202 by maintaining the voltage across the DC bus 210 to be equal to V_{MPPT} by controlling the operation of the AC load 214 to balance the amount of current drawn with the voltage output.

As previously discussed, in the absence of energy sources other than the PV array 202, the voltage across the DC bus 210 in FIG. 2 is equal to the voltage output by the PV array 202. Since the average electrical power is the change in work done for a given period of time, electrical power at the DC bus 210 usually cannot be reliably measured, and instead a voltage across the DC bus 210 is monitored and measured. As discussed in more detail below, the voltage across the DC bus 210 can be compared with a minimum required voltage or voltage threshold. When the voltage across the DC bus 210 is at the required voltage, this indicates that the AC load 214 is receiving enough power (or energy) to operate in an optimal or desired state.

The inverter 212 converts the DC voltage at the DC bus 210 to an AC voltage output. The output AC voltage is then provided to an AC load 214 via a voltage converter. The inverter 212 can operate using pulse width modulation (PWM) to control the rate of switching in the inverter 212, as would be understood by one skilled in the art. The PWM typically generates a high frequency and associated noise which should not reach the PV array 202 for safety or other reasons. In the system of FIG. 2, the DC filter 208 between the PV array 202 and the DC bus 210 prevents such noise from reaching the PV array 202. The DC filter 208 is a conventional DC filter which effectively blocks the noise from the PWM from reaching the PV array 202. Any suitable filter type may be used for this purpose or the filter may be omitted.

The AC load 214 requires a certain amount of power (or energy) to operate optimally. In the case of a motor, for example, optimal operation may be defined as achieving a desired speed or minimum desired speed of motor rotation. Alternatively, optimal operation may be that which enables the AC load to operate at its minimum operating power. In the case of the AC load being a water pump, the minimum operating power may be the power that enables the water pump to pump water to a particular height or volume.

The minimum amount of power required at the AC load 214 sets a corresponding “required voltage” level at the DC bus 210. When the AC load 214 is operating in an optimum or required state, the voltage across the DC bus 210 will be greater than or equal to the required voltage. In some instances, the output of the PV array 202 may be such that, when the PV array 202 is operating at its MPPT, the voltage V_{MPPT} output by the PV array 202 (and therefore the voltage across the DC bus 210) is greater than the required voltage, therefore indicating that the PV array 202 is producing more power than the minimum power needed by the AC load 214 to allow the AC load 214 to operate in a desired manner. In this situation, the current drawn from the AC load 214 can be increased in order to lower the voltage across the DC bus 210 back down to the minimum required voltage. In the case of the AC load 214 being a pump, this may be achieved by increasing the speed of the pump.

In the event that the power provided by the PV array 202, when operating at its maximum power point, is not enough to achieve optimum or desired operation of the AC load 214, there are three options. The first option is to not operate the AC load 214, since the power from the PV array 202 is not sufficient to allow the AC load 214 to operate optimally. The second option is to operate the AC load 214 in a less than optimal state, which may or may not be sufficient or acceptable for the system as a whole. The third option is to add one or more additional supplies to the system in order to provide additional power for the AC load 214.

In practice, environmental conditions such as varying irradiance, temperature and time of day may lead to the output of the PV array 202 being insufficient to ensure optimum or desired operation of the AC load 214 at all times. In this instance, the user could follow option two, as set out above, and so the operation of the AC load 214 can accordingly be adjusted such that the output of the photovoltaic array 202 is sufficient to operate the AC load 214 in a sub-optimal state. In the example of a motor or pump, this may comprise reducing the speed of rotation of the motor or reducing the speed of the pump.

Often, it is undesirable to operate the AC load in a sub-optimal state. Therefore the user would prefer to follow option three, above, if possible. In order to achieve optimal or desired operation of the AC load at times when the PV array 202 is unable to provide sufficient output, additional power may be taken from other sources. In the embodiment shown in FIG. 2, this additional power is supplied by an AC grid 204 which, in combination with the output of the photovoltaic array 202, is able to provide sufficient power to allow optimal or desired operation of the AC load 214. When choosing option three, consideration may be taken of the current electricity prices at that time of day which may or may not be acceptable to the user.

When, in the absence of other power sources, the PV array 202 operating at its maximum power point is unable to provide sufficient output to power the AC load 214 by itself, the voltage across the DC bus 210 decreases below the required level. The decrease in voltage across the DC bus 210 below the required voltage indicates to the inverter 212 that insufficient power is being provided to the AC load 214 and therefore more power must be taken from other energy sources. In FIG. 2 this other energy source is the AC grid 204. The AC grid 204 can supply the DC bus 210 with the additional power required to enable optimal or desired operation of the AC load 214. An input transformer 205 and a controlled AC-DC rectifier 206 electrically connect the AC grid 204 to the DC bus 210. The controlled AC-DC rectifier 206 converts the AC output of the AC grid 204 to a DC output. In the arrangement of FIG. 2, this DC output can be fed to the DC bus 210.

By controlling a current limit in the controlled AC-DC rectifier 206, an appropriate amount of additional power to compensate for the insufficient output of the PV array 202 is provided from the AC grid 204 to the DC bus 210. This causes the voltage across the DC bus 210 to increase up to the required level, indicating to the inverter 212 that the AC load 214 is being supplied with sufficient power to achieve optimum or desired operation.

The AC grid 204 outputs an AC voltage which remains roughly constant (typically about 1000V for some AC loads), therefore the current limit in the controlled AC-DC rectifier 206 is controlled so that only the minimum power required from the AC grid 204 is taken. By taking only the minimum amount of power from the AC grid 204, only minimum costs are incurred since the majority of the power supplied comes from the PV array 202.

The current limitation in the controlled AC-DC rectifier 206 may be achieved via thyristors as would be understood by the person skilled in the art. The current limit is controlled in the following manner: a predetermined amount of power is needed by the AC load 214 to enable the AC load 214 to operate at an optimum or required level, which is represented by the required voltage level across the DC bus 210. The system in FIG. 2 will aim to obtain all of the power needed by the AC load 214 from the PV array 202. However, as described above, at certain times the PV array 202 will be have to be assisted by the AC grid 204. The inverter 212 determines the extent to which the current limit in the AC-DC rectifier 206 must be increased so that the power supplied by the AC grid 204, in combination with the power supplied by the PV array 202, meets the power requirements of the AC load 214, and the current limit in the AC-DC rectifier 206 is adjusted accordingly. This results in an increase in the voltage across the DC bus 210—from a lower voltage up to the required voltage once the power supply from the AC grid 214 has been increased. This change in voltage across the DC bus 210 represents the power at the AC load 214 changing from an insufficient power to a sufficient minimum power for optimal or required operation.

During operation of the system of FIG. 2, the voltage across the DC bus 210 may decrease to less than the required voltage even in the presence of additional power sources. For example, the voltage across the DC bus 210 may initially be equal to the required voltage but, due to fluctuations in the output of the PV array 202 as a result of varying irradiance, temperature and time of day, the voltage across the DC bus 210 can decrease below the required voltage even when the PV array 202 and the AC grid 204 are both being output to the DC bus 210. According to an embodiment, the voltage level at the DC bus 210 is therefore monitored regularly and the current limit in the controlled AC-DC rectifier 206 is altered regularly to provide more or less power from the AC grid 204, in accordance with the instantaneous voltage at the DC bus 210, so that the power demands of the AC load 214 can be met over time.

Conversely, the voltage across the DC bus 210 may increase to a value greater than the required voltage when both the PV array 202 and the AC grid 204 are being used as supplies. For example, the PV array 202 may be operating at its maximum power point and working together with the AC grid 204 to initially provide the minimum power required for the AC load 214. At this point in time, the current limit in the controlled AC-DC rectifier 206 is set to a value that allows the AC grid 204 to provide sufficient power such that, together with the power supplied by the PV array 202, the minimum power requirements of the AC load 214 are met. Due to fluctuations in the output of the PV array 202 as mentioned above, the output of the PV array 202 may increase such that, when the PV array 202 is operating at its maximum power point together with the AC grid 204, the AC load 214 is receiving more power than the minimum power required.

In this scenario, an option is for the inverter 212 to adjust the operation of the AC load 214 to draw more current from the PV array 202, therefore lowering the voltage output by the PV array 202 and reducing the voltage across the DC bus 210 as a result. This means that the output of the PV array 202 is no longer equal to V_{MPPT}, and therefore the PV array 202 is not operating at its maximum power point. This approach is usually not desired, however, since it is likely to be cost effective to take as much power as possible from the PV array 202. Therefore a more cost effective approach is to maintain the PV array 202 at its maximum power point, and to instead change the current limit in the controlled AC-DC rectifier 206 in order to draw less power from the AC grid 204. In some cases, the fluctuations in the output of the PV array 202 may be such that power from the AC grid 204 is no longer needed at all and the PV array 202 alone is able to supply sufficient power to operate the AC load 218 in an optimal state. In this case, the current limit in the controlled AC-DC rectifier 206 would be reduced to OA such that no power is provided by the AC grid 204. By taking no power or the minimum power needed from the AC grid 204, costs are saved.

MPPT may be performed differently when the AC load 214 is being supplied by both the PV array 202 and the AC grid 204. When the AC load 214 is only being supplied by the PV array 202, the MPPT software in the inverter 212 maximises the power output of the PV array 202 by controlling the amount of current drawn by the AC load 214 from the PV array 202 in order to maintain the voltage output by the PV array 202 to be equal to V_{MPPT}, as previously described. However, when the AC load 214 is being supplied by both the PV array 202 and the AC grid 204, the voltage output by the PV array 202 may be maintained equal to V_{MPPT} without altering the operation of the AC load 214; thereby always ensuring that maximum power is taken from the PV array 202. Instead, additional current may be supplied to the AC load 214 by controlling the amount of current taken from the AC grid 204 via the controlled AC-DC rectifier 206. Therefore, less current may be drawn from the PV array 202, therefore allowing the voltage output by the PV array 202 to be equal to V_{MPPT}, and the AC grid 204 can make up for the reduction in current drawn by the PV array 202 by providing more power to the AC load 214.

Therefore, the AC load 214 can operate optimally at all times—effectively being ‘blind’ to any fluctuations in output power from the PV array 202—while still using the maximum power possible, and thus achieving the best efficiency, from the PV array 202.

If it is not desirable or not possible for the AC grid 204 to provide more current for cost or other reasons, more current may still be drawn from the PV array 202 when both the PV array 202 and the AC grid 204 are supplying the AC load 214 by controlling the amount of current drawn by the AC load 214, as previously described.

According to an embodiment, an algorithm is employed to automatically adjust the current limit in the AC-DC rectifier 206 in order to maintain the voltage across DC bus 210 to be as close as possible to the required voltage. Such an algorithm can have some or all of: the actual voltage across the DC bus 210, the required voltage across the DC bus 210, the voltage output of the PV array 202, the power required by the AC load 214, the schedule of costs of electricity from the AC grid 204 and the current limit and/or the voltage and power at the AC-DC rectifier 206 as variables. The algorithm can be employed by software run on any suitable processing means. For example, in the arrangement of FIG. 2, inverter software run on the inverter 212 can employ such an algorithm.

Therefore, the inverter 212 balances the aims of achieving MPPT for the PV array 202, meeting the power demands of the AC load 214, and controlling the current level in the AC-DC rectifier 206 in order to keep the cost of extracting power from the AC grid 204 as low as possible.

The DC bus 210 and inverter 212 may be an integral unit known as a “drive”, or may alternatively be separate units electrically connected. Inverters usually have an associated DC bus, but a separate DC bus may be desirable in some instances, for example if a higher voltage DC bus is required. A DC bus and inverter designed to output a high AC voltage, such as a high voltage DC bus and inverter designed to output 690Vac, may have a maximum DC bus voltage of 1150Vdc. This is likely to be considerably more expensive than a low voltage DC bus and inverter designed to output a lower AC voltage, for example 400Vac. Such a low voltage DC bus and inverter may have a maximum DC bus voltage of 800Vdc for example. The cost to buy a DC bus and associated inverter such as DC bus 210 and inverter 212 typically increases with increasing power. For a given power, a drive designed to output 400Vac would have a much higher current value than a drive designed to output 690Vac would. It has been recognised herein that a higher current value is desirable in order to allow the AC load to draw more current if needed, to enable the resultant system to have increased operating flexibility. It has been further recognised herein that it is not necessary to use a very high power drive, which can output high voltage and enable a large amount of current to be drawn therefrom. Instead, good and reliable results can be achieved by using a relatively low power (and thus low cost) drive, which enables a relatively large amount of current to be drawn therefrom but which has a low (e.g. 400Vac) output voltage.

Since the voltage output by the AC grid 204 is set to a standard value, typically about 1000Vac for high power AC loads, according to an embodiment, in order for the system of FIG. 2 to be able to use a low cost DC bus 210 or drive 210, 212, with a maximum DC bus voltage of 800Vdc, a voltage converter is located between the AC grid 204 and the controlled AC-DC rectifier 206. In the system of FIG. 2, the voltage converter is an input transformer 205. The input transformer 205 (which may also be referred to as a voltage conversion means) receives the 1000Vac supply from the AC grid 204 and reduces this voltage to a lower voltage, for example 575Vac, which the input transformer 205 supplies to the controlled AC-DC rectifier 206. The conversion from an AC voltage to a DC voltage by the controlled AC-DC rectifier 206 inherently results in a slightly increased DC voltage output from the controlled AC-DC rectifier, for example 660Vdc. Since the AC grid 204 is a voltage source, it is not possible for the current from the output of the controlled AC-DC rectifier 206 to be injected into the DC bus 210 unless the DC voltage output from the controlled AC-DC rectifier 206 is greater than the voltage level across the DC bus 210. The PV array 202 is a current source and therefore is always able to provide current to the DC bus 210 regardless of voltage levels. The maximum operating voltage (maximum V_{MPPT}) of the PV array 202 sets the maximum voltage across the DC bus 210, which may be for example 630Vdc. According to an embodiment, the input transformer 205 and controlled AC-DC rectifier 206 are therefore chosen such that the voltage output of the controlled AC-DC rectifier 206 is always greater than the maximum operating voltage of the PV array 202 to ensure that current from the AC grid 204 can reach the DC bus 210.

As mentioned above, for a given power, a drive (comprising a DC bus and inverter) designed to output a lower AC voltage will have an increased current value. However, the AC load being driven by the drive may require a higher AC voltage than that output by the drive. For example, the AC load 214 may be a high voltage AC load, such as a 690Vac-1000Vac load with a power rating of over 200 kW. A typical example of a high voltage AC load is a motor driving a water pump in a sewage processing plant. For such a high voltage AC load, in order to use a low voltage DC bus and inverter (“drive”) designed to output an AC voltage lower than that required by the AC load 214 (for example 400Vac), a voltage converter is required to increase the voltage output from the inverter 212. The voltage converter may be an output transformer 213. The voltage at the DC bus 210 is determined by the operating voltage (V_{MPPT} for given environmental conditions) of the PV array 202, as previously described. The minimum operating voltage of the PV array 202 may be 550Vdc, for example. Under some environmental conditions, for example high temperature, the voltage output by the inverter 212, after converting the voltage from the DC bus 210 from a DC to an AC voltage, may be less than the minimum operating voltage of the PV array 202 due to the conversion process. For example, for a minimum operating voltage of the PV array 202 of 550Vdc, the output of the inverter 212 may be only 340Vac. The AC load 214 requires a voltage of between 690Vac and 1000Vac to operate, therefore the output transformer 213 converts the voltage output from the inverter 212 to a higher voltage. In this example, the output transformer 213 (which may also be referred to as voltage conversion means) converts the voltage output from the inverter 212 from 340Vac to 1000Vac.

Therefore, in order to allow a wide range of current values to be drawn by the AC load 214, it has been recognised herein that it is preferable and more cost effective to use a drive designed to output a lower AC voltage, for example 400Vac, in conjunction with the output transformer 213 than to use a drive designed to output a higher AC voltage, for example 690Vac.

Environmental conditions may cause the power output from the PV array 202 to decrease so low that the power output from the PV array 202 becomes insufficient to maintain a connection to the DC bus 210, and the PV array 202 will therefore become disconnected from the DC bus 210. In this case, the AC grid 204 may supply all of the power required by the AC load 214 to allow the AC load 214 to operate in a desired manner. In this instance, the voltage across the DC bus 210 is equal to the voltage output from the AC-DC rectifier 206. This situation may occur during the night, for example, when the PV array 202 is unable to operate.

The system of FIG. 2 may also comprise a sinusoidal filter (not shown) located between the inverter 212 and the output transformer 213. PWM in the inverter 212 reduces the performance of a conventional transformer such as output transformer 213, and the sinusoidal filter is therefore able to reduce the effect of PWM on the output transformer 213. By using a sinusoidal filter, a conventional transformer such as output transformer 213 may be used in the system of FIG. 2, and therefore a simpler and more cost effective system is provided. Alternatively, the function of the sinusoidal filter may be incorporated in a transformer which could therefore be placed in the system of FIG. 2 instead of the sinusoidal filter and output transformer 213.

The system of FIG. 2 therefore provides an efficient system for operating a high voltage AC load using a combination of a PV array and an AC grid. The system is configured such that power from the AC grid is only used when necessary for the AC load, and only the minimum amount of power is taken. According to an embodiment, further cost savings are made by using a DC bus and inverter (or drive) designed to output a relatively low voltage (400Vac), in conjunction with input and output transformers, while still providing a reliable system to power a high voltage AC load. In this way the cost of a DC bus and inverter (or drive unit) designed to output both a high current and a high voltage (690Vac) is avoided. Therefore it has been recognised herein that, since the AC grid supplies a very high voltage (1000Vac) and the AC load requires both a very high voltage to operate (690Vac-1000Vac) and a range of current values to work with, AC voltage converters (such as transformers), in conjunction with a DC bus and inverter (drive) designed to output a low AC voltage, provide a cost effective and flexible system for powering an AC load.

Alternative voltage converters (which may also be referred to as voltage conversion means) such as DC/DC converters may be used. However, DC/DC converters represent a considerable increase in cost due in part to the increased wiring costs associated with using a DC/DC converter, since much thicker wiring is needed. Further, using a DC/DC converter also increases the complexity of the system over the transformers and controlled AC-DC rectifier configuration presented in FIG. 2, and therefore the use of a DC/DC converter is usually not desirable.

A second embodiment is shown by way of example in FIG. 3 and comprises a system 300. In the system 300, the PV array 202 and the AC grid 204 work together as part of a multi jog system to operate multiple AC loads 214a, 214b. As in the first embodiment shown in FIG. 2, the PV array 202 is connected to DC bus 210 via a DC filter 208. An AC supply such as the AC grid 204 is connected via an input transformer 205 and an AC-DC rectifier 206 to the DC bus 210, as previously described. The DC bus 210 connects to multiple inverters 212a, 212b to convert the DC output from the DC bus 210 to an AC output from each inverter 212a, 212b. Again, in the same manner as the first embodiment shown in FIG. 2, each inverter 212a, 212b connects to a respective output transformer 213a, 213b to increase the AC voltage level to a required level for the load. The output of the output transformers 213a and 213b is connected to a respective AC load 214a, 214b.

One AC load 214a acts as master, and the other 214b as slave. If the DC bus 210 is only supplied by the PV array 202, the inverter 212a of the master AC load 214a controls the amount of current drawn by the master AC load 214a to ensure that a maximum power is output by the PV array 202, as previously described. Therefore, the inverter 212a of the master AC load 214a controls the MPPT of the PV array 202. Software in the inverter 212a determines the voltage across the DC bus 210 which corresponds to the V_{MPPT} of the PV array 202. Once the voltage across the DC bus 210 corresponding to the V_{MPPT} of the PV array 202 has been determined, this voltage is communicated to the other inverter 212b, which operates its respective slave AC load 214b, and both AC loads 214a and 214b operate in such a way to draw enough current from the PV array 202 for this voltage level across the DC bus 210 to be met.

If both the PV array 202 and the AC grid 204 supply the DC bus 210, the power supplied to the AC loads 214a and 214b may be such that desired operation of both the master AC load 214a and the slave AC load 214b is achieved at all times, depending on the needs of the user. This desired operation may be achieved by increasing or decreasing the current provided by the AC grid 204, as previously described, which may or may not be acceptable to the user taking into account the cost of taking power from the AC grid 204 at that time.

In the system of FIG. 3, since there is more than one AC load, the power supplied needs to be greater in order for both AC loads 214a and 214b to operate as desired. Due to the increased power demand from multiple AC loads, in some situations only the master AC load 214a may be operated. This may be the case for example if the PV array 202 is only able to supply enough power to allow desired operation of the master AC load 214a. The electricity costs at a specific time of day or requirements of the system may mean that a choice is made not to also supply power from the AC grid 204 at such a time, and so only the master AC load 214a can be operational. Alternatively, if desired, additional power may be provided by the AC grid 204 to allow operation of both the master AC load 214a and the slave AC load 214b. The decision on whether or not to take power from the AC grid 204 may be based on the needs of the system, and/or on the specific scheduling of electricity costs for that time of day, which can be incorporated into an algorithm in the inverter 212a which controls the controlled AC-DC rectifier 206.

The system of FIG. 3 may initially only power the master AC load 214a. However, as in the first embodiment shown in FIG. 2, in some situations the output of the PV array 202 may be such that, after MPPT has been carried out, the voltage across the DC bus 210 is greater than the minimum required voltage for the master AC load 214a, therefore indicating that the master AC load 214a is receiving more power than the minimum power required to operate in a desired or optimal manner. However, the power received by the master AC load 214a may still be insufficient to power both the master AC load 214a and the slave load 214b simultaneously. The inverter 212a therefore adjusts the power output by the PV array 202 to a point offset and away from the MPPT point, thereby causing the PV array 202 to output less power by controlling the amount of current drawn from the PV array 202 such that the voltage output of the PV array 202 is not equal to V_{MPPT}. Therefore, in this situation the PV array 202 has the capability to provide more power than that required by the master AC load 214a, but the MPPT is adjusted by the inverter 212a to ensure that the required voltage of the DC bus 210 is not exceeded.

The PV array 202 may be able to provide considerably more power than that required by the master AC load 214a. For example, the PV array 202 may be able to provide 130% of the required power. This provides the system of FIG. 3 with the option of operating only the master AC load 214a in an optimal state (at 100% of the power requirements of the master AC load 214a) by adjusting the output of the PV array 202 such that only 100% of power required by the master AC load 214a reaches the master AC load 214a, or operating both the master AC load 214a and the slave AC load 214b, albeit in a potentially sub-optimal state. For example, when the PV array 202 is able to provide 130% of the power required by the master AC load 214a, the inverter may allow the PV array 202 to work at its maximum power point and provide 130% of the power to the master AC load 214a. Since the master AC load 214a does not need this much power, the software in the master inverter 212a triggers operation of the slave inverter 212b and the slave AC load 214b and a portion of the power output by the PV array 202 is provided to the slave AC load 214b. This allows both the master AC load 214a and the slave AC load 214b to operate simultaneously. For example, both the master AC load 214a and the slave AC load 214b could operate at 65% of their optimal or desired power. The optimal or desired power required to operate both the master AC load 214a and the slave AC load 214b could be the same, or alternatively the master and slave loads 214a, 214b may have different respective optimal or desired power requirements.

The operation of two AC loads at a reduced power may be desirable in some instances depending on the needs of the system. Both the master AC load 214a and slave AC load 214b may alternatively be operated in an optimal state by supplementing the power output by the PV array 202 with power supplied by the AC grid 204 in the manner previously described in relation to FIG. 2. This may or may not be desirable, depending on the needs of the system and the electricity costs at that time.

Although only two AC loads have been described in the system of FIG. 3, any number of AC loads could by present. For example, four AC loads could be present comprising one master AC load and three slave AC loads.

Multiple rectifiers such as controlled AC-DC rectifier 206 may be used if the input power from the AC grid 204 which is required to ensure optimal or desired operation of multiple AC loads is greater than that supported by a single rectifier. Additionally, multiple rectifiers may be used to ensure that each AC load is independent of any other AC load.

Further, multiple DC buses may be present, thereby providing each AC load with its own inverter and DC bus combination (“drive”).

Any AC supply may be used in conjunction with a PV array, and the AC supply is not limited to the AC grid.

Another renewable energy source may be used instead of, or in addition to, a PV array.

According to an embodiment, more than two power supplies may be controlled in order to provide power supply to an end load.

The power demands at the load may change over time and/or the capability of one or more of the power sources may change over time, for example due to changes in environmental factors. The principles of the improved method described herein can be applied to control operation of the power supplies—including controlling if and when each of them should be used to supply power and, when used, to what extent—to ensure that the load's power demands are met in a cost-effective, effective and reliable manner.

The improved method and system described herein therefore enable required operation of one or more AC loads. The AC loads are, according to an embodiment, supplied exclusively by a PV array when possible, but in the event that the power supplied by the PV array is not sufficient, the system only takes the minimum power needed to ensure optimal or required operation of the AC loads from an AC supply. Accordingly, the disclosed system provides significant cost savings by using renewable energy generated by an end user as a primary source and only seeking energy from the AC supply when the renewable energy supply is not sufficient. Further, only the minimum energy required is taken from the AC supply, thereby providing further environmental and cost savings.

The term “optimal operation” has been used to describe an operation of an AC load that is desired by an operator of the system at a certain point in time. However this term should not be construed as limiting and another term may instead be used. For example, “optimal operation” of the AC load may be the AC load working at its maximum efficiency, in terms of, for example, financial cost or energy consumption. In the example of the AC load being a motor, “optimal operation” may be the motor working at a maximum speed of rotation or at a most efficient power level. In the example of the AC load being a pump, “optimal operation” may be the pump pumping water to a required height or volume in a certain time. Alternatively, “optimal operation” may be the operation of the AC load that is acceptable for the operator, taking into account electricity costs and the needs of the system.

The term “PV array” has been used herein to describe one or more photovoltaic cells. Any other suitable term such as “PV string” or “solar panel” may instead be used.

The supply of power to an end load from two or more sources, as described herein, can be monitored and controlled by any suitable means such as an industrial controller, a processor such as a microprocessor, or a computer. A computer, such as a general-purpose computer, can be configured or adapted to perform the described methods. In one embodiment the computer comprises a processor, a memory, and a display. Typically, these are connected to a central bus structure, the display being connected via a display adapter. The computer can also comprise one or more input devices (such as a mouse and/or keyboard) and/or a communications adapter for connecting the computer to other computers or networks. These are also typically connected to the central bus structure, the input device being connected via an input device adapter.

In operation the processor can execute computer-executable instructions held in the memory and the results of the processing are displayed to a user on the display. User inputs for controlling the operation of the computer may be received via input device(s).

A computer readable medium (e.g. a carrier disk or carrier signal) having computer-executable instructions adapted to cause a computer to perform the described methods may be provided.

Embodiments have been described by way of example only. It will be appreciated that variations of the described embodiments may be made. For example, the AC load may be any load requiring an AC voltage to operate. The DC filter 208 may be any filter that achieves the desired effect of blocking the noise from the PWM from reaching the PV array 202. The sinusoidal filter described may be any such filter which reduces the effect of PWM on the output transformer 213. Alternatively, the output transformer 213 may include the functionality of such a filter, such that the same benefits of reducing the effect of PWM on the output transformer 213 may be achieved without including a stand-alone filter in the system.

1. A method of controlling an electrical power supply to an AC load, wherein said load has an associated power threshold, the method comprising:
providing a drive configured to output an AC voltage lower than that required by the load, the drive having an input and being arranged to output to a first voltage converter before power from the drive is output to the load;
using a first electrical power source to generate a first amount of power for supply to the load, wherein said first electrical power source comprises a renewable source and wherein the first electrical power source is arranged to output power to the input of the drive;
comparing the first amount of power generated by the first electrical power source with the power threshold associated with the load;
as a result of said comparison, determining whether to supply power to the load from the first power source and further determining whether to supply a second amount of power to the load from a second, different electrical power source, the second electrical power source being arranged to output to a second voltage converter before power from the second electrical power source is output to the input of the drive; and
if it is determined that the second electrical power source should be used to supply a second amount of power to the load, controlling an output of the second electrical power source so that a combined amount of power supplied to the load from the first and second electrical power sources meets the power threshold associated with the load.

2. The method of claim 1 wherein the first electrical power source comprises one or more photovoltaic (PV) cells, and/or optionally the method further comprising the step of controlling an output of the first electrical power source so that the first amount of power generated by the first electrical power source is maximised.

3. The method of claim further 1 including the step of, when the comparison step of claim 1 indicates that there is a shortfall amount between the first amount of power generated by the first electrical power source for supply to the load and the power threshold associated with the load, controlling an output of the second electrical power source so that the second amount of power generated by the second electrical power source is as close as possible to said shortfall amount.

4. The method claim 1 wherein the second electrical power source is arranged to provide electrical power at a substantially constant voltage, and wherein the method comprises controlling a current level for the second electrical power source in order to control the second amount of power supplied to the load by the second electrical power source, and optionally wherein the step of controlling the current level for the second electrical power source is performed by a rectifier.

5. The method of claim 1 wherein the power threshold associated with the load comprises an amount of power required by the load in order to achieve an operational requirement, and optionally wherein said operational requirement comprises any of: operating at a predetermined speed, operating at a predetermined torque, or operating to achieve a predetermined height or volume of fluid, and further optionally wherein operating at a predetermined speed, predetermined torque, or predetermined height or volume of fluid comprises operating at a maximum speed, maximum torque, or maximum height or volume of fluid respectively.

6. The method of claim 1 wherein the drive comprises a bus and an inverter electrically connected to the bus, and optionally wherein the power threshold associated with the load is represented by a voltage threshold of the bus or drive.

7. The method of claim 6 wherein the inverter is arranged to output to the second voltage converter before power from the inverter is output to the load.

8. The method of claim 1 comprising repeating the steps of claim 1 periodically.

9. A method of operating a load comprising controlling the electrical power supply to said load as defined in claim 1.

10. A computer, processor or controller adapted to perform the method of claim 1.

11. A non-transitory computer readable medium having computer-executable instructions adapted to cause a computer system to perform the method of claim 1.

12. A system for controlling an electrical power supply to an AC load, wherein said load has an associated power threshold, the system comprising:
a drive configured to output an AC voltage lower than that required by the load, the drive having an input and being arranged to output to a first voltage converter before power from the drive is output to the load;
a first electrical power source arranged to generate a first amount of power for supply to the load, wherein said first electrical power source comprises a renewable source and wherein the first electrical power source is arranged to output power to the input of the drive;
a second electrical power source arranged to output to a second voltage converter before power from the second electrical power source is output to the input of the drive;
a processor; and
a non-transitory computer readable medium having computer executable instructions adapted to cause the processor to:
compare the first amount of power generated by the first electrical power source with the power threshold associated with the load;
determine, as a result of said comparison, whether to supply power to the load from the first power source, and whether to supply a second amount of power to the load from the second electrical power source; and
if it is determined that the second electrical power source should be used to supply a second amount of power to the load, control an output of the second electrical power source so that a combined amount of power supplied to the load from the first and second electrical power sources meets the power threshold associated with the load.

13. The system of claim 12 wherein the first electrical power source comprises one or more photovoltaic (PV) cells, and/or optionally wherein the second electrical power source comprises an alternating current (AC) grid.

14. The system of claim 12 wherein the second electrical power source is arranged to provide electrical power at a substantially constant voltage and wherein the computer executable instructions are adapted to cause the processor to control a current level for the second electrical power source in order to control the second amount of power supplied to the load by the second electrical power source.

15. The system of claim 14 wherein the current level is a current level of a rectifier.

16. The system of claim 12 wherein the drive comprises a bus and an inverter electrically connected to the bus.

17. The system of claim 16 wherein the inverter is arranged to output to the second voltage converter before power from the inverter is output to the load.

18. The system of claim 12 wherein the first voltage converter comprises a transformer, and/or wherein the second voltage converter comprises a transformer.

19. The system of claim 12 further comprising a first filter, wherein the first electrical power source is arranged to output to the first filter, and optionally the system further comprising a second filter, wherein the inverter is arranged to output to the second filter before being output to the second voltage converter, or wherein the drive is arranged to output to the second filter before being output to the second voltage converter.

20. The system of claim 12 wherein the load is an AC motor or an AC pump.
